(19) United States
(12) Patent Application Publication
(10) Pub. No.: US 2026/0140893 A1
(43) Pub. Date: May 21, 2026

(54) SCALING OF TENANT'S DATA FOR A CLOUD DELIVERED SAAS CONTROLLER BY USING IN-MEMORY DATA STORES

(71) Applicant: Cisco Technology, Inc., San Jose, CA (US)

(72) Inventors: Jeffrey Yi Dar Lo, Cupertino, CA (US); Daniel Eric Talayco, Mountain View, CA (US); Robert Stephen Rodgers, Mountain View, CA (US); Kyle Andrew Donald Mestery, Woodbury, MN (US); Thomas John Giuli, Mountain View, CA (US); Michael Dodd, Fremont, CA (US)

(21) Appl. No.: 19/249,387

(22) Filed: Jun. 25, 2025

Related U.S. Application Data
(60) Provisional application No. 63/722,582, filed on Nov. 19, 2024.

(51) Int. Cl. G06F 13/16; G06F 8/71

(52) U.S. Cl. CPC G06F 13/1668; G06F 8/71; G06F 2213/16

(57) ABSTRACT

In some embodiments, a method of adaptively synchronizing state data, includes updating an in-memory data with at least one current state change, receiving a data subscription request, registering, the data subscription request upon a determination that the data subscription request is valid, identifying one or more data objects associated with the subscription request, retrieving the current version of the one or more data objects, and transmitting the one or more data objects.

### CROSS-REFERENCE TO RELATED APPLICATION

This application claims the benefit of priority to U.S. Provisional Application No. 63/722,582, filed Nov. 19, 2024, the disclosure of which is incorporated by reference herein in its entirety.

The present disclosure relates to communication networks. More particularly, the present disclosure relates to scaling of tenant data within fabric devices of a cloud delivered SaaS such that memory on compute nodes can be utilized as the primary storage mechanism.

### BACKGROUND

A network fabric may be an interconnected architecture of switches and routers in data centers or enterprise environments, forming a grid that enables efficient, high-speed data transfer across various components such as servers, storage devices, and applications. By linking devices directly or in closely connected layers, a network fabric may facilitate seamless communication and reduce bottlenecks. A leaf-spine system is one such network topology commonly used within a network fabric to ensure efficient data transfer, wherein “spine” switches may be positioned as the backbone of the network, connecting to all “leaf” switches, which in turn may connect directly to servers and other end devices.

Cloud controllers may add another layer of efficiency and centralization to network fabrics, allowing for the remote management of network resources and automation of complex networking tasks. In many embodiments, a cloud controller may be configured as a software-based management tool accessible through the internet, allowing IT teams to manage and control the network remotely. Its role may be to oversee the network fabric, providing a high-level, centralized view of all the activity and performance within the network. This centralized control may allow for real-time adjustments to optimize data flow across the network fabric, identify less busy routes, and reroute data to maintain performance.

Integrating artificial intelligence (AI) workloads into network fabrics may leverage the low-latency, high-throughput nature of these interconnected systems to support data-heavy and computation-intensive AI tasks. AI applications, such as machine learning, may rely on fast, constant access to large data sets and powerful computational resources, which network fabrics may facilitate by creating direct, efficient pathways between components. However, undertaking and completing the integration of AI into network fabrics may come with significant challenges. Handling the massive data transfers and low-latency demands of AI can strain even well-designed network fabrics, and security and data governance concerns may also be heightened. Finally, scaling the network to accommodate expanding AI demands can lead to compatibility and performance issues, making the management of such networks a challenging endeavor

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a network, in accordance with various embodiments of the disclosure;

FIG. 2 is a conceptual illustration of transferring data traffic between devices in a network, in accordance with various embodiments of the disclosure;

FIG. 3 is a schematic block diagram of an example architecture for a network fabric, in accordance with various embodiments of the disclosure;

FIG. 4 is a conceptual network diagram of various environments that an adaptive state synchronization logic may operate, in accordance with various embodiments of the disclosure;

FIG. 5 is a flowchart depicting a process for managing a high-level state data synchronization lifecycle in accordance with various embodiments of the disclosure;

FIG. 6 is a flowchart depicting a process for handling state data subscription requests and transmissions in accordance with various embodiments of the disclosure;

FIG. 7 is a flowchart depicting a process for optimizing synchronized state data transmission in accordance with various embodiments of the disclosure; and

FIG. 8 is a conceptual block diagram of a device suitable for configuration with an adaptive state synchronization logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DESCRIPTION OF EXAMPLE EMBODIMENTS

### Overview

In some embodiments, a method of adaptively synchronizing state data, includes updating an in-memory data with at least one current state change, receiving a data subscription request, registering, the data subscription request upon a determination that the data subscription request is valid, identifying one or more data objects associated with the subscription request, retrieving the current version of the one or more data objects, and transmitting the one or more data objects.

### Example Embodiments

In response to the issues described above, devices and methods are discussed herein that provide for the scaling of tenant's data for a cloud delivered SaaS controller by using in-memory data stores as a primary storage mechanism. This approach addresses common challenges in modern network management, including reliable data access and processing efficiency issues such as scaling data structures to fit into a host's memory. By utilizing a fine-grained, subscription-based state synchronization model, the systems and methods described can provide timely and relevant data from a plurality of network devices to a central controller in a highly efficient and scalable manner. This model can be applied not only to device telemetry and configuration, but as a fundamental communication fabric for many components of a distributed system, including user interfaces, active-standby replication, and read replicas.

The systems and methods described herein can be used to overcome the inherent limitations of traditional data extraction models used in the networking industry. One such model is traditional polling, where a central manager, such as a Simple Network Management Protocol (SNMP) manager, repeatedly sends requests to network nodes to gather their current state at a set cadence. This model can be inefficient, as it may expend significant network bandwidth and compute resources to repeatedly request information that has not changed. For example, polling a statistic that remains at a zero value every fifteen seconds for several months can be a worthless use of resources. Another model is the push or streaming telemetry model, where a device continuously sends data updates to a consumer. A primary challenge in this model can be managing the data rate; if a consumer is unable to keep up, it may delay reading from the data socket, which can cause unbounded queuing of intermediate state on the source device, eventually consuming all available memory and causing the source process to crash.

Embodiments described herein may address these issues by employing a hybrid model that functions more like a routing protocol than a traditional telemetry stream. The system may be considered a state synchronization system, where the primary goal is to synchronize the current state of a data object, not to transmit a series of historical events or samples. This can be achieved through a fine-grained subscription model with filtering, where a consumer can subscribe to specific data objects of interest. Once subscribed, the system can provide updates without the consumer needing to send repeated requests. As a core design principle, this synchronization model may discard intermediate state updates. For example, if a consumer is unable to receive an update for any reason, that specific update is not queued for later delivery; instead, the system will simply provide the next available current state when communication is possible.

This state synchronization approach may provide several benefits related to performance and resiliency. The system may exhibit more graceful degradation under slow or congested network conditions, because it is only ever attempting to transmit the current state, not a large backlog of previous states. This also allows for an optimization of data transfer, as the system can be configured to only uplift bytes that have an inherent economic value, avoiding the cost of transmitting stale or redundant information. This model is not limited to device-to-controller communication; it can be used as a foundational communication system between various distributed processes. For instance, it can be used to synchronize state between an active and standby controller instance, or to deliver real-time state updates to a web browser serving as a user interface.

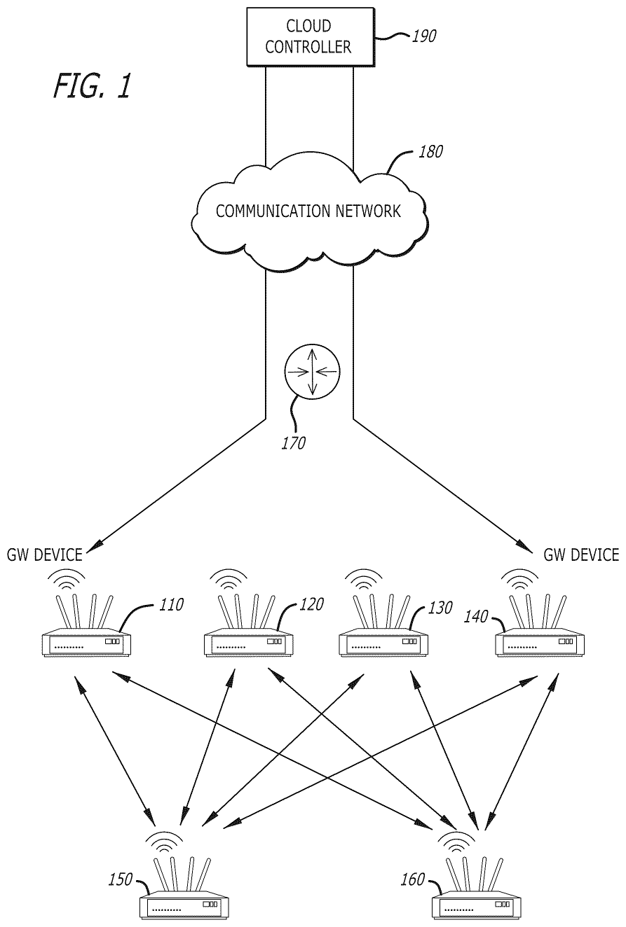

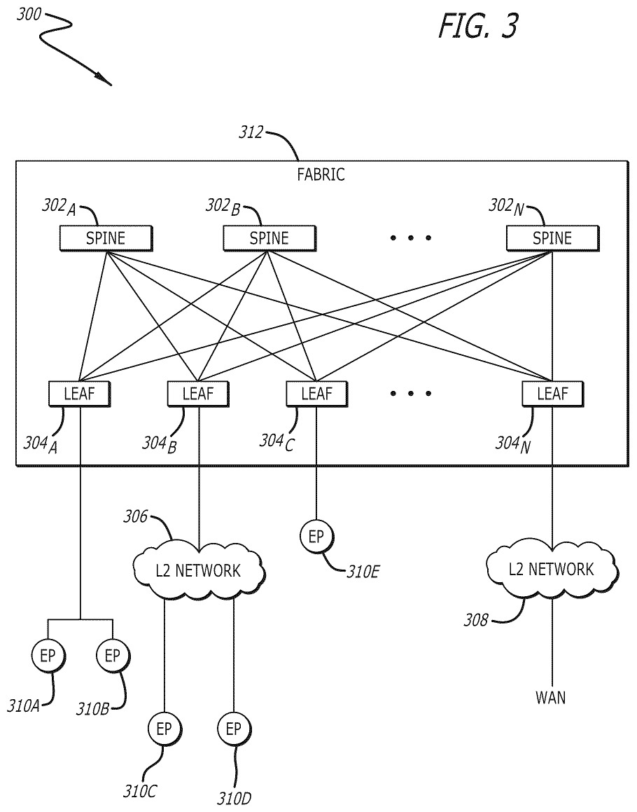

In many embodiments, a cloud controller may be a centralized system that manages and coordinates the various networking components within a network fabric environment. It may act as a central point of intelligence for the network, ensuring that all parts work together seamlessly and can be managed remotely, often as a Software-as-a-Service (SaaS) offering accessible via the internet. The cloud controller may be responsible for providing a high-level, comprehensive view of all activity and performance within the network, allowing it to make real-time adjustments to optimize data flow. This centralized management role is critical for deploying, monitoring, and scaling complex applications and network architectures, such as those shown in FIGS. 1 and 3.

In some embodiments, the cloud controller may utilize an adaptive state synchronization logic to interact with the managed network devices. For example, the cloud controller may initiate a data subscription request to a network device to receive timely updates on its operational state or telemetry data. The controller then receives the synchronized current state data from the devices, which it can use for various purposes, including updating user interfaces, applying new configurations, or making decisions about network optimization. By using the efficient state synchronization methods described herein, the cloud controller can effectively manage a large number of tenant devices without being overwhelmed by redundant or stale data, enabling the entire system to scale.

Schemas, as they relate to embodiments described herein, may be a high-level, formally defined structure that describes a hierarchical data model for telemetry and configuration data. This schema notion may be shared across all participating entities, including various services within the cloud controller and the adaptive state synchronization logic running on the network devices. This shared understanding of the data structure is fundamental to the system's operation, as it ensures that data transmitted between the controller and the devices is consistent, predictable, and can be correctly interpreted by the recipient. The schema may serve as the blueprint for all state and configuration information managed by the system.

In various embodiments, the schema may be used to facilitate code generation, which can instantiate a per-service view of schema objects. This means that the same data object defined in the schema may have a different implementation or level of detail depending on the service consuming it; for example, a configuration service may only need to know if a port is up or down, while a detailed telemetry service might require granular packet counters for that same port. Furthermore, the schema definition can be used by a code generator to define the specific messages, such as protocol buffer (protobuf) messages, that are used to serialize and transmit the data objects between all services and devices.

A hierarchical data model, in accordance with various embodiments described herein, may refer to the organization of data objects into a tree-like structure with parent-child relationships, as defined by the schema. This model provides a logical and structured way to represent complex network configurations and states, where certain data objects may be naturally dependent on or contained within others. For example, the state of a physical port could be a child object of the switch it belongs to, which in turn could be a child object of the network fabric it is a part of. This structure allows for a more intuitive and manageable representation of the entire network ecosystem.

The use of a hierarchical data model may provide several functional benefits for the adaptive state synchronization logic. The relationships defined in the model can be used to establish rules for data processing and transmission. For instance, the transmission of one or more data objects can be ordered based on rules associated with the hierarchical data model to ensure that dependencies are respected. A network interface configuration might need to be transmitted and applied before any routing protocol configurations that depend on that interface can be sent. This hierarchical approach ensures data integrity and consistency when applying configurations or interpreting state across the distributed system.

Schema objects may be the individual, fully qualified instances of data that conform to the structure defined by the schema. These are not merely unstructured log messages, but rather complete data entities with defined attributes and a place within the overall hierarchical data model. For example, a schema object could represent the configuration of a single VLAN, the real-time telemetry data for a specific port on a leaf switch, or the operational state of a proxy agent on a gateway device. The adaptive state synchronization logic operates on these schema objects, identifying, retrieving, and transmitting them in response to data subscription requests.

In many embodiments, the system may utilize a per-service view of these schema objects, as facilitated by code generation based on the schema. This means a single conceptual schema object, such as a “network port,” may be represented differently for different consumers. A configuration service might interact with a version of the port schema object that only contains fields for administrative status and speed settings. In contrast, a performance monitoring service might interact with a different version of that same port schema object that includes dozens of granular packet counters and error statistics. This flexibility allows each service to handle only the data it needs, which contributes to the overall efficiency and scalability of the system.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

Referring to FIG. 1, a conceptual illustration of a network, in accordance with various embodiments of the disclosure is shown. The network may include a plurality of network devices such as a first network device 110, a second network device 120, a third network device 130, a fourth network device 140, a fifth network device 150, and a sixth gateway device 160, a router 170, a communication network 180, and a cloud controller 190. The communication network 180 can be the internet or another suitable wide area network. The sixth gateway device 160 may operate as an exit node for data being transmitted from the local network environment to the cloud controller 190.

In various embodiments, the cloud controller 190 and the plurality of network devices may each contain processing and memory components that comprise an adaptive state synchronization logic. This logic can be configured to manage the efficient exchange of information, such as state data and telemetry data, between the devices and the central controller. This architecture may allow the cloud controller 190 to provide centralized management and configuration for the various network devices, which may act as nodes within a larger network fabric.

The adaptive state synchronization logic may be configured to operate based on a subscription model. For instance, the cloud controller 190 may transmit a data subscription request to one or more of the network devices, such as to the first network device 110. The logic on a receiving network device can be configured to receive this request and, upon determining that the request is valid, register the data subscription request for further processing. In some embodiments, a data subscription request may comprise at least one filter, which can be used by the logic to identify the specific data objects associated with that request.

In many embodiments, each of the network devices, including the first network device 110, the second network device 120, the third network device 130, the fourth network device 140, and the fifth network device 150, may be configured to continuously update an in-memory data store with at least one current state change related to their operational status or collected telemetry. When a subscription is registered, the adaptive state synchronization logic can identify the one or more data objects associated with the request and retrieve the current version of those objects directly from the in-memory data. This process ensures that any data prepared for transmission reflects the most up-to-date state available on the device.

In further embodiments, the logic may be configured to ensure the efficiency and relevance of the data transmission. The adaptive state synchronization logic can be configured to evaluate if state data is stale and discard any data that is evaluated as such. This may prevent the transmission of outdated information. Furthermore, before transmission, the one or more data objects may be compressed and formatted as payload data. To facilitate this, the formatting may comprise serializing the data objects. The logic may also monitor one or more network conditions and dynamically adapt the transmission of the data to maintain performance.

In additional embodiments, the data objects being synchronized can conform to a hierarchical data schema. This schema may be shared between the cloud controller 190 and each of the network devices to ensure a common understanding of the data structure. In certain embodiments, the transmission of the one or more data objects can be ordered based on one or more rules associated with this hierarchical data schema, which may be useful for processing data with dependencies. This overall system may create a dynamic and resilient structure where data can flow seamlessly and efficiently from many devices to a central controller for management and monitoring at scale.

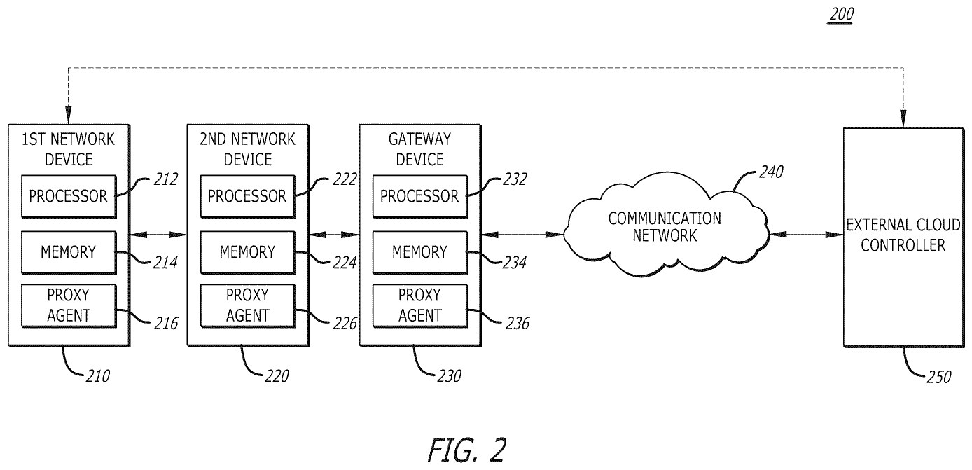

Although a specific embodiment for a network for carrying out the various steps, processes, methods, and operations described herein is discussed with respect to FIG. 1, any of a variety of systems and/or processes may be utilized in accordance with embodiments of the disclosure. For example, the first network device 110 and the second network device 120 may be configured with different hardware or software capabilities, yet still participate in the same state synchronization fabric through the adaptive state synchronization logic. The elements depicted in FIG. 1 may also be interchangeable with other elements of FIGS. 2-8 as required to realize a particularly desired embodiment.

Referring to FIG. 2, a conceptual illustration of transferring data traffic between devices in a network, in accordance with various embodiments of the disclosure is shown. The network 200 may include a first network device 210, a second network device 220, a gateway device 230, a communication network 240, and an external cloud controller 250. The first network device 210 may be in communication with the second network device 220, which in turn may be in communication with the gateway device 230. Each of these devices may include its own respective processor, such as a first processor 212, a second processor 222, and a third processor 232. Similarly, each device may include a memory, such as a first memory 214, a second memory 224, and a third memory 234, and a proxy agent, such as a first proxy agent 216, a second proxy agent 226, and a third proxy agent 236.

In various embodiments, the processor and memory on each device, such as the first processor 212 and the first memory 214, may be configured to execute an adaptive state synchronization logic. The proxy agent, such as the first proxy agent 216, can be a component of this logic that is responsible for forwarding data traffic when a direct connection to a destination is not available. The memory on each device, such as the first memory 214, can be used to store in-memory data. This in-memory data may be continuously updated with at least one current state change related to the device's operational status or telemetry data.

The system shown may facilitate communication between the external cloud controller 250 and a device that does not have a direct connection, such as the first network device 210. For example, the external cloud controller 250 may transmit a data subscription request intended for the first network device 210. This request may be received by the gateway device 230 and forwarded, or proxied, by its third proxy agent 236 to the second network device 220. Subsequently, the second proxy agent 226 on the second network device 220 may forward the request to the first network device 210, establishing a logical communication path.

Upon receiving the proxied request, the adaptive state synchronization logic on the first network device 210 may register the data subscription request after determining that it is valid. The logic may then identify one or more data objects associated with the subscription request, potentially using one or more filters included in the request. Once the data objects are identified, the logic may retrieve the current version of the one or more data objects from the in-memory data stored in the first memory 214.

To ensure efficient and relevant data transfer back to the external cloud controller 250, the logic on the first network device 210 may perform several data preparation actions. The logic may be configured to evaluate if the retrieved state data is stale and discard it to prevent transmitting outdated information. The logic may then compress the one or more data objects and format them as payload data, which can involve serializing the data. This prepared payload data, representing the current state, may then be transmitted from the first network device 210 to the second network device 220.

In many embodiments, the prepared payload data may be relayed hop-by-hop back to the controller. The second network device 220 may receive the payload data from the first network device 210, and its second proxy agent 226 may forward the data to the gateway device 230. The third proxy agent 236 on the gateway device 230 may then forward the data through the communication network 240 to the external cloud controller 250. The transmission of these data objects may be ordered based on one or more rules associated with a shared hierarchical data schema to ensure data integrity.

Although a specific embodiment for a network 200 for carrying out the various steps, processes, methods, and operations described herein is discussed with respect to FIG. 2, any of a variety of systems and/or processes may be utilized in accordance with embodiments of the disclosure. For example, the number of intermediate devices between a first network device and a gateway device could be greater or fewer than the single second network device 220 shown. The elements depicted in FIG. 2 may also be interchangeable with other elements of FIGS. 1 and 3-8 as required to realize a particularly desired embodiment.

Referring to FIG. 3, a schematic block diagram of an example architecture for a network fabric, in accordance with various embodiments of the disclosure is shown. The architecture 300 may feature a fabric 312, which can be a high-speed, high-bandwidth interconnect system designed to provide a flexible and scalable infrastructure for environments such as data centers. The fabric 312 may be configured in a leaf-spine architecture that includes a plurality of spine switches, such as a first spine switch 302A, a second spine switch 302B, and an Nth spine switch 302N. The fabric 312 may also include a plurality of leaf switches, such as a first leaf switch 304A, a second leaf switch 304B, a third leaf switch 304C, and an Nth leaf switch 304N, where each leaf switch may be connected to each spine switch to provide multiple redundant paths for data traffic.

In some embodiments, a spine switch, such as the first spine switch 302A, may be an L3 switch within the fabric 312, and may also perform L2 functionalities. A spine switch can support various high-speed capabilities and may be configured with one or more high-speed Ethernet ports. In certain embodiments, a port on a spine switch may also be split to support other speeds. Each spine switch and leaf switch may be configured with an adaptive state synchronization logic, which enables efficient, centralized management by a cloud controller (not shown).

A leaf switch, such as the first leaf switch 304A, may reside at the edge of the fabric 312 and can thus represent a physical network edge. In some cases, a leaf switch can be a top-of-rack (“ToR”) switch, or in other cases, an aggregation switch in an end-of-row (“EoR”) or middle-of-row (“MoR”) topology. A leaf switch may include access ports, which can provide connectivity for devices and external networks to the fabric 312, and fabric ports, which can provide uplinks to the spine switches. The logic on a leaf switch may be responsible for routing and bridging various packets and applying network policies.

In additional embodiments, a leaf switch, such as the second leaf switch 304B, can perform further functions. These may include implementing a mapping cache, encapsulating packets, and enforcing ingress or egress policies. A leaf switch may also contain virtual switching functionalities, such as a virtual tunnel endpoint (VTEP) function. Furthermore, a spine switch, such as the second spine switch 302B, can be configured to host a proxy function. This proxy function may perform a lookup of an endpoint address identifier in a mapping database on behalf of a leaf switch that does not have such a mapping. When a packet is received, the spine switch can check if the destination is a proxy address and, if so, perform the lookup to forward the packet to the correct locator address.

Network connectivity for various endpoints may be provided through the leaf switches. For example, a first endpoint 310A and a second endpoint 310B may connect directly to the first leaf switch 304A. A third endpoint 310C and a fourth endpoint 310D may connect to the second leaf switch 304B by way of a first L2 network 306. A fifth endpoint 310E may connect directly to the third leaf switch 304C. An external network, such as a WAN, may also connect to the fabric 312 via a second L2 network 308 and a leaf switch. These endpoints may include any communication device, such as a server, computer, or other switch, and may host virtual workloads, clusters, or applications.

The adaptive state synchronization logic on the switches enables a central controller to manage the state of the fabric 312 and its connected endpoints. The controller may transmit a data subscription request, which can include at least one filter, to a leaf switch to gather telemetry data or state data. The logic on the leaf switch may then register the request, identify the relevant data objects, and retrieve the current version of those objects from an in-memory data store that it continuously updates. To ensure efficiency, the logic can evaluate if state data is stale and discard it, and can compress and serialize the data objects before transmission.

In certain embodiments, such as an AI-focused setup, this architecture may be adapted to meet the unique demands of AI workloads, which can require high bandwidth and low latency. The adaptive state synchronization logic allows a cloud controller to monitor network traffic patterns and other network conditions within the fabric 312. Based on this monitored information, the controller can make decisions to dynamically adjust virtualized paths to balance loads, reduce latency, and ensure critical AI processes receive prioritized access to network resources. The data synchronized may conform to a hierarchical data schema, and the transmission of data objects can be ordered based on rules associated with this schema to ensure consistent state application.

Although a specific embodiment for an architecture 300 for a network fabric 312 is described with respect to FIG. 3, any of a variety of systems and/or processes may be utilized in accordance with embodiments of the disclosure. For example, the fabric 312 could be deployed in a single data center or be distributed across multiple physical locations, with the adaptive state synchronization logic managing state across the entire deployment. The elements depicted in FIG. 3 may also be interchangeable with other elements of FIGS. 1-2 and 4-8 as required to realize a particularly desired embodiment.

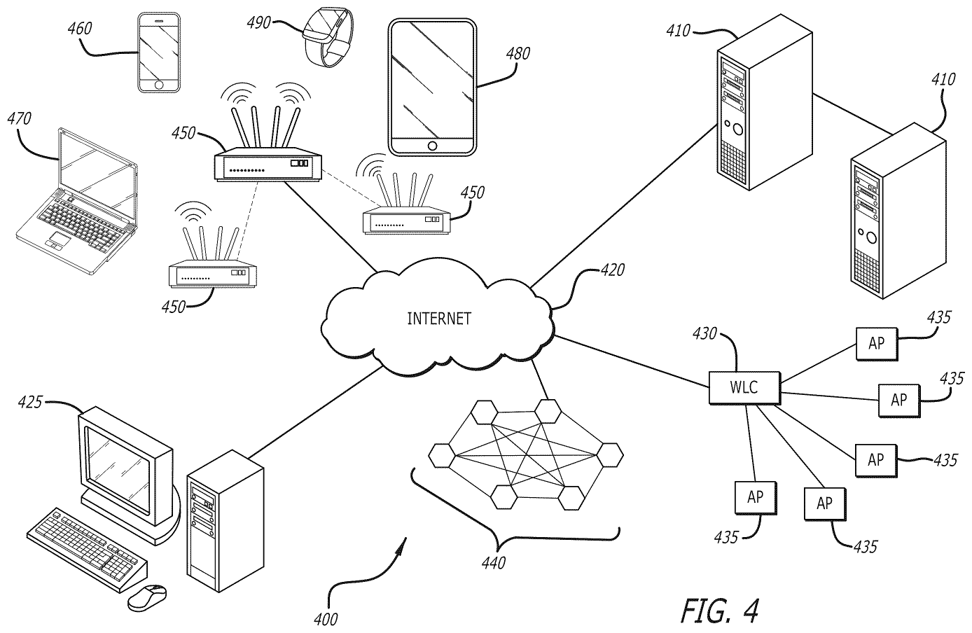

Referring to FIG. 4, a conceptual network diagram of various environments that an adaptive state synchronization logic may operate, in accordance with various embodiments of the disclosure is shown. This diagram 400 depicts a plurality of computing devices and network infrastructure components that can be interconnected, representing potential environments where state management and synchronization functionalities, such as those provided by an adaptive state synchronization logic, may be deployed or utilized.

In many embodiments, the diagram 400 includes components often found in enterprise or data center environments, such as one or more servers 410 and potentially a deployed network 440. The servers 410 could host applications, services, or the cloud controller component of the state synchronization system. In some embodiments, a server 410 or a desktop computer 425 could host or interact with the adaptive state synchronization logic used to manage the state of various network segments. The deployed network 440, depicted abstractly, could represent a complex network fabric, such as the spine-leaf architectures described herein, whose operational state is monitored and synchronized. These components can be interconnected via a network 420, such as the Internet.

In various embodiments, the diagram 400 also illustrates access network components. These can include devices like wireless access points 450 that provide network connectivity to various end-user devices. Additionally, a wireless LAN controller (WLC) 430 managing multiple access points (APs) 435 is shown, representing a centrally managed wireless network infrastructure. The state of these access network components, such as connected client lists or traffic statistics, could be collected and managed via the adaptive state synchronization logic. These access network components facilitate communication between end-user devices and other network resources, such as the servers 410 or services within the deployed network 440.

In certain embodiments, a variety of end-user devices are shown connecting through the access network components. These can include devices such as a cellular phone 460, a laptop computer 470, a portable tablet or smartphone 480, and a wearable computing device 490. These devices can act as sources of state changes within the overall network environment, such as by connecting, disconnecting, or generating traffic. In some embodiments, managing the network's response to these devices might involve using the adaptive state synchronization logic to provide timely state updates to a central controller.

In some embodiments, the environment depicted in FIG. 4 illustrates the heterogeneity of networks where state synchronization may be applied. The adaptive state synchronization logic and associated methods could be applied selectively to different parts of this environment. For instance, the synchronization of state data from a high-performance deployed network 440 might be more frequent or granular than the state synchronized from an end-user device connecting via one of the wireless access points 450. A controlling entity, perhaps located on one of the servers 410 or operating as a cloud service accessible via the network 420, could manage state synchronization sessions across these diverse network segments.

Although a specific embodiment for various network environments and devices is discussed with respect to FIG. 4, any of a variety of systems and device arrangements may be utilized in accordance with various embodiments. For example, the adaptive state synchronization logic could be hosted on one of the servers 410 and used to manage the state of end-user devices, such as the laptop computer 470, connecting through one of the wireless access points 450. The elements depicted in FIG. 4 may also be interchangeable with other elements of FIGS. 1-3 and 5-8 as required to realize a particularly desired embodiment.

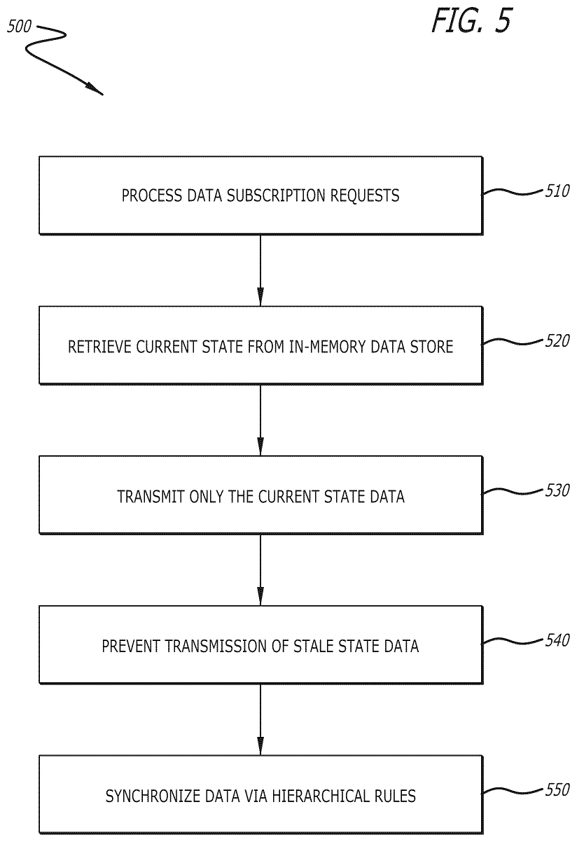

Referring to FIG. 5, a flowchart depicting a process for managing a high-level state data synchronization lifecycle, in accordance with various embodiments of the disclosure is shown. In many embodiments, the process 500 can process data subscription requests (block 510). For example, a data subscription request may originate from a cloud controller seeking telemetry data from a network device. In a non-limiting example, a data subscription request may comprise one or more filters that specify a subset of data objects to be synchronized.

In a number of embodiments, the process 500 can retrieve current state from an in-memory data store (block 520). It is contemplated that the in-memory data store may be continuously updated with current state changes to ensure that any retrieved data is the most recent version available. For instance, the retrieval may be triggered in direct response to a valid and registered subscription request for one or more specific data objects.

In more embodiments, the process 500 can transmit only the current state data (block 530). This approach may ensure that the receiving entity, such as a cloud controller, operates on the most timely and relevant information available from the data source. In some embodiments, the current state data may be compressed and serialized into payload data prior to transmission to increase efficiency.

In further embodiments, the process 500 can prevent transmission of stale state data (block 540). For example, the process may involve evaluating if a retrieved data object has been superseded by a more recent update and discarding the older version from a transmission queue. This prevention of stale data transmission may reduce unnecessary network bandwidth consumption and processing load on both the transmitting and receiving devices, which can be critical for scalability.

In additional embodiments, the process 500 can synchronize data via hierarchical rules (block 550). It is contemplated that the hierarchical rules may be derived from a shared hierarchical data schema that defines relationships and dependencies between different data objects. For instance, the rules may be used to determine the correct order for transmitting data objects to ensure that dependencies are met, such as sending a network interface configuration before sending routing information that relies on that interface.

Although a specific embodiment for a process 500 for managing a high-level state data synchronization lifecycle suitable for carrying out the various steps, processes, methods, and operations described herein is discussed with respect to FIG. 5, any of a variety of systems and/or processes may be utilized in accordance with embodiments of the disclosure. For example, the steps shown may be performed by an adaptive state synchronization logic operating on a cloud controller, a network device, or distributed across both. The elements depicted in FIG. 5 may also be interchangeable with other elements of FIGS. 1-4 and 6-8 as required to realize a particularly desired embodiment.

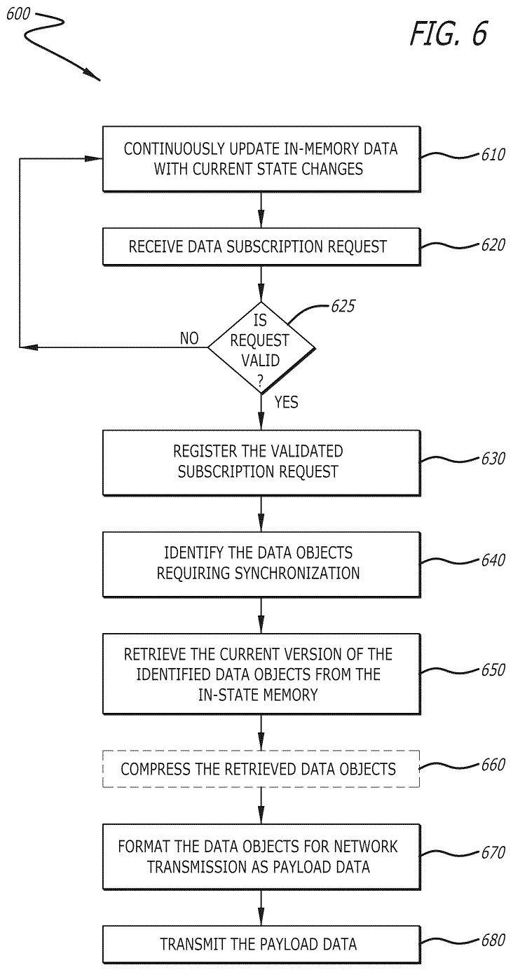

Referring to FIG. 6, a flowchart depicting a process for handling state data subscription requests and transmissions, in accordance with various embodiments of the disclosure is shown. In many embodiments, the process 600 can continuously update in-memory data with current state changes (block 610). For example, the at least one current state change can be associated with telemetry data received from a network device's physical port or operational state data related to a running service. It is contemplated that this continuous updating ensures that the in-memory data store serves as an accurate, up-to-date source for any subsequent data retrieval operations.

In a number of embodiments, the process 600 can receive a data subscription request (block 620). For instance, the data subscription request may be received from a central cloud controller managing a fabric of network devices. In some embodiments, the data subscription request may comprise at least one filter that specifies particular conditions or data types the requesting entity is interested in.

In more embodiments, the process 600 can determine if a request is valid (block 625). If the process 600 determines that the request is not valid, then the process 600 may once again continuously update in-memory data with current state changes (block 610). However, if the request is determined to be valid, then the process 600 can register the validated subscription request (block 630). For example, registering the request may involve creating an entry in a subscription table that links the requesting entity to the specific data objects or filters in the request. It is contemplated that this registration allows the system to efficiently track active subscriptions and manage data synchronization accordingly.

In further embodiments, the process 600 can identify the data objects requiring synchronization (block 640). This identification may be based on the parameters of the registered subscription request, including any associated filters. In certain embodiments, the identified data objects may comprise state data, configuration data, or telemetry data conforming to a shared hierarchical data schema.

In additional embodiments, the process 600 can retrieve the current version of the identified data objects from the in-state memory (block 650). Retrieving the current version ensures that any data transmitted is timely and reflects the most recent state known to the device, preventing the propagation of stale information. In some embodiments, the logic may evaluate if the state data is stale prior to or during retrieval and may be configured to discard any data evaluated as such.

In still more embodiments, the process 600 can compress the retrieved data objects (block 660). For instance, compression may be applied to reduce the size of the payload data, which can conserve network bandwidth and improve transmission speed, especially over slower or congested network links. It is contemplated that the decision to compress the data objects may be based on a pre-configured policy, the size of the data, or dynamically adapted based on monitored network conditions.

In yet further embodiments, the process 600 can format the data objects for network transmission as payload data (block 670). For example, the formatting can comprise serializing the one or more data objects into a structured message format, such as one or more protocol buffer (protobuf) messages. This formatting ensures the data is in a standardized, transmittable format that can be easily parsed and understood by the receiving entity.

In still additional embodiments, the process 600 can transmit the payload data (block 680). The transmission may be ordered based on one or more rules associated with a hierarchical data schema to ensure data dependencies are respected. In some embodiments, the transmission rate and other parameters may be dynamically adapted based on monitored network conditions to ensure reliable and efficient delivery.

Although a specific embodiment for a process 600 for handling state data subscription requests and transmissions suitable for carrying out the various steps, processes, methods, and operations described herein is discussed with respect to FIG. 6, any of a variety of systems and/or processes may be utilized in accordance with embodiments of the disclosure. For example, the determination of validity at block 625 could involve checking cryptographic signatures, validating against a list of authorized subscribers, or verifying that the request conforms to the data schema. The elements depicted in FIG. 6 may also be interchangeable with other elements of FIGS. 1-5 and 7-8 as required to realize a particularly desired embodiment.

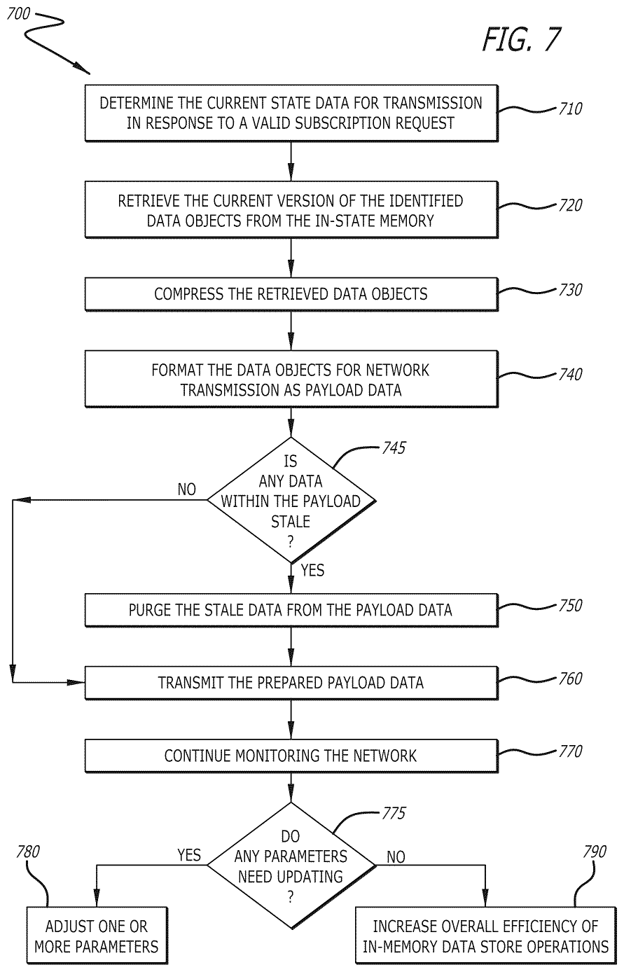

Referring to FIG. 7, a flowchart depicting a process for optimizing synchronized state data transmission, in accordance with various embodiments of the disclosure is shown. In many embodiments, the process 700 can determine the current state data for transmission in response to a valid subscription request (block 710). For instance, this can involve identifying one or more data objects that correspond to the filters and scope defined in a registered subscription. It is contemplated that the determination may also include cross-referencing the required data with a local cache or in-memory data store to confirm the availability of a current version.

In a number of embodiments, the process 700 can retrieve the current version of the identified data objects from the in-state memory (block 720). This retrieval process may be designed to have minimal impact on the performance of the device by utilizing efficient memory access patterns. For example, the retrieved data objects can comprise telemetry data, such as port statistics, or operational state data, such as the status of a device service.

In more embodiments, the process 700 can compress the retrieved data objects (block 730). The compression can utilize various algorithms, and the choice of algorithm may be selected dynamically based on the data type or available processing resources. In a non-limiting example, compressing the data objects may significantly reduce the amount of bandwidth required to transmit the data across a network.

In further embodiments, the process 700 can format the data objects for network transmission as payload data (block 740). For example, the formatting may comprise serializing the one or more data objects into a structured message that can be easily parsed by the recipient. It is contemplated that this formatting step ensures the data is encapsulated correctly for transport across various network layers.

In additional embodiments, the process 700 can determine if any data within the payload is stale (block 745). If the process 700 determines that no data within the payload is stale, then the process 700 can transmit the prepared payload data (block 760). However, if it is determined that some data is stale, then the process 700 can purge the stale data from the payload data (block 750). For example, purging the stale data may involve removing specific data objects from the serialized payload that have been superseded by more recent updates. This action ensures that only the most current and relevant information is ultimately transmitted.

In still more embodiments, the process 700 can transmit the prepared payload data (block 760). The transmission can be sent to a cloud controller or another network device acting as a proxy or aggregator. In certain embodiments, the transmission of the payload data may be ordered based on one or more rules associated with a hierarchical data schema.

In yet further embodiments, the process 700 can continue monitoring the network (block 770). This monitoring may involve observing network conditions such as latency, jitter, or packet loss on the transmission path. For instance, the monitoring can also include tracking the resource utilization, such as CPU and memory usage, on the transmitting device itself.

In still additional embodiments, the process 700 can determine if any parameters need updating (block 775). If the process 700 determines that no parameters need updating, then the process 700 can increase the overall efficiency of in-memory data store operations (block 790). However, if it is determined that one or more parameters need updating, then the process 700 can adjust one or more parameters (block 780). For example, adjusting the parameters may involve dynamically adapting the transmission rate or changing the compression algorithm in response to the monitored network conditions. It is contemplated that these adjustments allow the system to maintain optimal performance in a changing network environment.

In yet more embodiments, the process 700 can increase the overall efficiency of in-memory data store operations (block 790). This can include performing routine maintenance on the in-memory data store, such as garbage collection or memory defragmentation. For instance, increasing efficiency may also involve re-indexing data or optimizing data structures to improve the speed of subsequent data retrieval operations.

Although a specific embodiment for a process 700 for optimizing synchronized state data transmission suitable for carrying out the various steps, processes, methods, and operations described herein is discussed with respect to FIG. 7, any of a variety of systems and/or processes may be utilized in accordance with embodiments of the disclosure. For example, the purging of stale data could be based on timestamps, version numbers, or a notification from a source service indicating an update. The elements depicted in FIG. 7 may also be interchangeable with other elements of FIGS. 1-6 and 8 as required to realize a particularly desired embodiment.

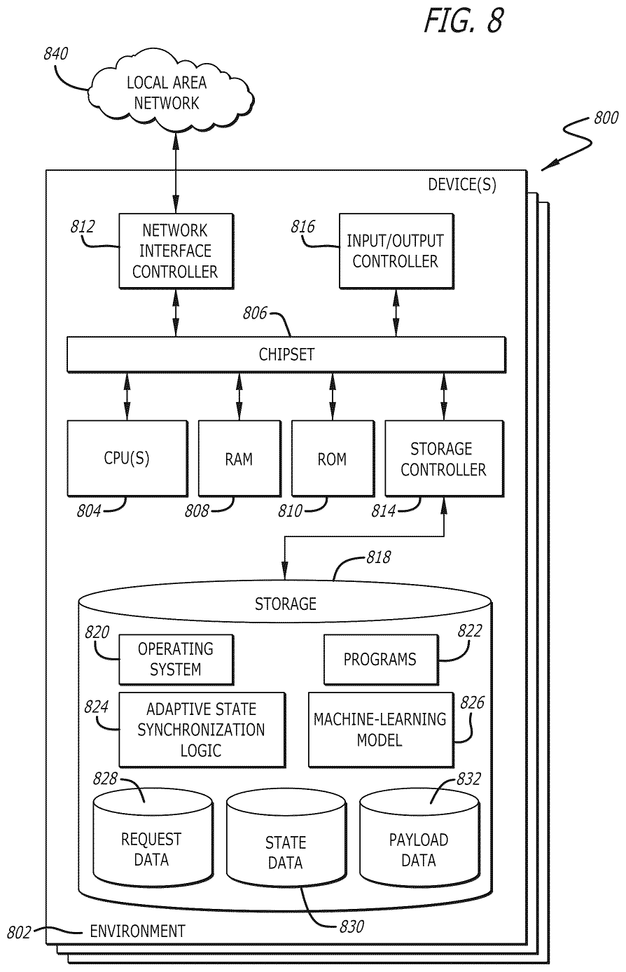

Referring to FIG. 8, a conceptual block diagram of a device 800 suitable for configuration with a adaptive state synchronization logic, in accordance with various embodiments of the disclosure is shown. The embodiment of the conceptual block diagram depicted in FIG. 8 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many non-limiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (RAM 808), which can be used as the main memory in the device 800 in some embodiments. The chipset 806 can further be configured to provide an interface to a computer-readable storage medium such as a read-only memory (ROM 810) or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822, request data 828, state data 830, and payload data 832. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by the device 800 or additional similar devices operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as applications 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In many embodiments, the adaptive state synchronization logic 824 may be the central component responsible for executing the various processes and methods for state synchronization described herein. The adaptive state synchronization logic 824 can be configured to manage the end-to-end lifecycle of a data synchronization event. This may begin when the adaptive state synchronization logic 824 processes a data subscription request from the request data 828. Upon validating and registering the subscription, the adaptive state synchronization logic 824 can identify the one or more data objects required for synchronization from the state data 830. It may then retrieve the current version of these objects from the in-memory data store and prepare them for transmission by compressing and serializing them into payload data, which can be stored in the payload data 832 store.

In further embodiments, the adaptive state synchronization logic 824 may be configured with a variety of intelligent and optimization-focused capabilities. A primary function of the adaptive state synchronization logic 824 can be to ensure data integrity and efficiency by evaluating if state data is stale and discarding it to prevent the transmission of outdated information. The adaptive state synchronization logic 824 can also operate based on a shared hierarchical data schema, which it may use to order the transmission of data objects correctly. Furthermore, the “adaptive” nature of the adaptive state synchronization logic 824 may stem from its ability to monitor one or more network conditions and dynamically adapt transmission parameters, such as rate or compression levels, to maintain performance. In some embodiments, the adaptive state synchronization logic 824 may also interface with one or more machine-learning models 826 to predictively enhance its adaptive responses.

In various embodiments, the storage 818 may be configured to store request data 828. The request data 828 may contain information related to one or more data subscription requests that have been received by the device 800. For example, a request can be received from a cloud controller or another network device and can specify a request for certain types of telemetry data or state data. The stored request data 828 may also include any parameters associated with the request, such as at least one filter that can be used to define the specific scope of the subscription.

The adaptive state synchronization logic 824 may utilize the request data 828 as an input for its operations. The adaptive state synchronization logic 824 can parse the request data 828 to determine if a data subscription request is valid, and upon validation, can register the subscription for active monitoring. Furthermore, the adaptive state synchronization logic 824 can use the details within the request data 828, such as any included filters, to identify the specific one or more data objects that are required for a synchronization event.

In many embodiments, the storage 818 may also be configured to store state data 830. The state data 830 can be the in-memory data store that is continuously updated with at least one current state change occurring on or observed by the device 800. This data can comprise various types of information, including telemetry data such as port statistics, and operational state data such as the status of hardware components or running software processes. The data objects within the state data 830 may be structured according to a shared hierarchical data schema.

The state data 830 may serve as the primary source from which the adaptive state synchronization logic 824 retrieves information for transmission. When a subscription is active, the adaptive state synchronization logic 824 can access the state data 830 to retrieve the current version of the one or more requested data objects. The adaptive state synchronization logic 824 may also interact with this data store to evaluate if certain state data is stale, for example, by comparing version numbers or timestamps, before it is retrieved for transmission.

In certain embodiments, the storage 818 may be configured to store payload data 832. The payload data 832 can serve as a temporary staging area for data that has been retrieved and prepared for outbound transmission. For example, after data objects are retrieved from the state data 830, they may be compressed and formatted as payload data before being stored in this area. The formatting can include serializing the data into a structured message format.

The adaptive state synchronization logic 824 may use the payload data 832 store for final processing before network transmission. In some embodiments, the adaptive state synchronization logic 824 can perform a final check on the data stored as payload data 832 to identify and purge any data that may have become stale between the time of retrieval and the time of transmission. Once the payload data is finalized, the adaptive state synchronization logic 824 can transmit the payload data 832 to the subscribing entity.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controllers 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

Finally, in numerous additional embodiments, data may be processed into a format usable by one or more machine-learning models 826 (e.g., feature vectors), and or other pre-processing techniques. The one or more machine-learning models 826 may be any type of machine-learning model, such as supervised models, reinforcement models, and/or unsupervised models. The one or more machine-learning models 826 may include one or more of linear regression models, logistic regression models, decision trees, Naïve Bayes models, neural networks, k-means cluster models, random forest models, and/or other types of models.

In some embodiments, the adaptive state synchronization logic 824 may operate in conjunction with one or more machine-learning models 826. One or more machine-learning models 826 can be trained on historical data from the various data stores, such as patterns in the request data 828 or trends observed in the state data 830. The one or more machine-learning models 826 may learn to recognize correlations between certain network conditions and data update patterns.

The one or more machine-learning models 826 may be configured to generate inferences that enhance the adaptive capabilities of the adaptive state synchronization logic 824. For instance, one or more machine-learning models 826 could predict future network congestion based on telemetry trends and advise the adaptive state synchronization logic 824 to proactively adjust its transmission rate or compression level. In another example, the one or more machine-learning models 826 could learn to identify which types of state data are most likely to become stale, allowing the adaptive state synchronization logic 824 to more efficiently evaluate and discard stale data, thereby increasing the overall efficiency of the synchronization process.

In summary, devices, networks, systems, methods, and processes for dynamically proxying traffic between interconnects of devices in a fabric are described herein. A communication network may include multiple switches, including gateway switches and non-gateway switches. Each switch can run a proxy agent for each port of the switch and for each link on each port. The switch may proxy data traffic within the communication network by utilizing the proxy agent. A non-gateway switch can send a connection request to a gateway switch to connect to an external cloud controller. The gateway switch may proxy the connection request to the external cloud controller and receive a session cookie. The non-gateway switch can establish a logical connection with the external cloud controller based on the session cookie.

Although a specific embodiment for a device suitable for configuration with an adaptive state synchronization logic 824 for carrying out the various steps, processes, methods, and operations described herein is discussed with respect to FIG. 8, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor; and
a memory communicatively coupled to the processor, wherein the memory comprises an adaptive state synchronization logic that is configured to:
update an in-memory data with at least one current state change;
receive a data subscription request;
register, the data subscription request upon a determination that the data subscription request is valid;
identify one or more data objects associated with the data subscription request;
retrieve a current version of the one or more data objects; and
transmit the one or more data objects.

2. The device of claim 1, wherein the one or more data objects are compressed prior to transmission.

3. The device of claim 2, wherein the one or more data objects are formatted as payload data.

4. The device of claim 3, wherein the formatting of the one or more data objects comprises at least serializing the payload data.

5. The device of claim 1, wherein the data subscription request comprises at least one filter.

6. The device of claim 5, wherein the one or more data objects are identified based on the at least one filter.

7. The device of claim 1, wherein the one or more data objects conform to a hierarchical data schema.

8. The device of claim 7, wherein transmitting of the one or more data objects is ordered based one or more rules associated with the hierarchical data schema.

9. The device of claim 1, wherein the adaptive state synchronization logic is further configured to monitor one or more network conditions.

10. The device of claim 9, wherein the adaptive state synchronization logic is further configured to dynamically adapt a transmission of the one or more data objects based on the one or more network conditions.

11. The device of claim 1, wherein updating the in-memory data is performed continuously.

12. The device of claim 11, wherein the adaptive state synchronization logic is further configured to evaluate if state data is stale.

13. The device of claim 12, wherein the adaptive state synchronization logic is further configured to discard state data that is evaluated as stale.

14. The device of claim 1, wherein the at least one current state change is associated with the one or more data objects.

15. The device of claim 1, wherein the one or more data objects comprises state data.

16. The device of claim 1, wherein the one or more data objects comprises telemetry data.

17. A method of adaptively synchronizing state data, comprising:
updating an in-memory data with at least one current state change;
receiving a data subscription request;
registering, the data subscription request upon a determination that the data subscription request is valid;
identifying one or more data objects associated with the data subscription request;
retrieving a current version of the one or more data objects; and
transmitting the one or more data objects.

18. The method of claim 17, further comprising formatting the one or more data objects into payload data prior to transmitting the one or more data objects.

19. The method of claim 18, further comprising evaluating the payload data for stale data.

20. The method of claim 19, further comprising purging stale data from the payload data.
